(19) United States
(12) Patent Application Publication
(10) Pub. No.: US 2011/0219386 A1
(43) Pub. Date: Sep. 8, 2011

(54) METHOD AND APPARATUS FOR GENERATING BOOKMARK INFORMATION

(75) Inventors: In-Chul HWANG, Suwon-si (KR); Mun-Jo KIM, Suwon-si (KR)

(73) Assignee: SAMSUNG ELECTRONICS CO., LTD., Suwon-si (KR)

(21) Appl. No.: 13/041,782

(22) Filed: Mar. 7, 2011

Related U.S. Application Data
(60) Provisional application No. 61/310,930, filed on Mar. 5, 2010.

(30) Foreign Application Priority Data
Feb. 22, 2011 (KR) 10-2011-0015575

(51) Int. Cl. G06F 9/46

(52) U.S. Cl. 719/328

(57) ABSTRACT

A method and apparatus of generating and storing bookmark information regarding a point of time during reproduction of audio/video (AV) content are provided. The information storage apparatus includes: a browser driver which drives a browser, the browser including an application programming interface (API) which generates information regarding a point of time according to reproduction of audio/video (AV) content; and a storage unit which stores the information regarding the point of time, wherein the API generates the information regarding the point of time by receiving metadata regarding the point of time from an application program related to the reproduction of the AV content, and matching the metadata with an identifier of the AV content.

### CROSS-REFERENCE TO RELATED PATENT APPLICATIONS

This application claims the benefit of U.S. Provisional Application No. 61/310,930, filed on Mar. 5, 2010, and claims priority from Korean Patent Application No. 10-2011-0015575, filed on Feb. 22, 2011 in the Korean Intellectual Property Office, the disclosures of which are incorporated herein in their entireties by reference.

### BACKGROUND

1. Field

Apparatuses and methods consistent with exemplary embodiments relate to generating bookmark information, and more particularly, to generating and storing information regarding a predetermined point of time during reproduction of audio/video (AV) content.

2. Description of the Related Art

A service, via which a broadcast signal is transmitted and received in the form of a digital signal is referred to as a “digital broadcasting service.” Since not only content but also an application program may be transmitted and received via a broadcast signal, various services, e.g., video on-demand (VOD) and an advertisement, may be provided based on the application program.

A device, e.g., a television (TV), which receives and reproduces a digital broadcast signal, provides an environment, e.g., a browser, for enabling an application program received via a broadcast signal to be smoothly executed.

### SUMMARY

One or more exemplary embodiments provide a method and apparatus for generating and storing information regarding a predetermined point of time during reproduction of AV content, according to a user input.

One or more exemplary embodiments also provide a computer readable recording medium having recorded thereon a computer program for executing the method described above.

According to an aspect of an exemplary embodiment, there is provided an information storage apparatus including: a browser driver which drives a browser that includes an application programming interface (API) generating information regarding a predetermined point of time according to reproduction of AV content; and a storage unit which stores the information regarding the predetermined point of time, wherein the API receives metadata regarding the predetermined point of time from an application program related to the reproduction of the AV content, and generates the information regarding the predetermined point of time by matching the metadata with an identifier of the AV content.

The information regarding the predetermined point of time may include information regarding a still image of the AV content at the predetermined point of time.

The AV content may include digital content.

In the storage unit, the information regarding the predetermined point of time may be stored in a location determined by the browser.

The browser driver may provide the application program with information regarding the location of the storage unit, in which the information regarding the still image is stored.

According to an aspect of another exemplary embodiment, there is provided an information reading apparatus including: a storage unit which stores information regarding a predetermined point of time, which is generated according to reproduction of AV content; and a browser driver which drives a browser including an API that reads the information regarding the predetermined point of time and transmits this information to an application program related to the reproduction of the AV content, wherein the information regarding the predetermined point of time is generated by receiving metadata regarding the predetermined point of time from the application program and matching the metadata with an identifier of the AV content, and wherein the API transmits the metadata included in the information regarding the predetermined point of time to the application program.

According to an aspect of another exemplary embodiment, there is provided an information storage method including: receiving metadata regarding a predetermined point of time determined according to reproduction of AV content from an application program related to reproduction of the AV content; generating information regarding the predetermined point of time by matching the metadata with an identifier of the AV content; and storing the information regarding the predetermined point of time in a storage device.

According to an aspect of another exemplary embodiment, there is provided an information reading method including: receiving a request to read information regarding a predetermined point of time, which is generated according to reproduction of AV content, from an application program related to reproduction of the AV content; reading the information regarding the predetermined point of time from a storage device, in response to the received request; and extracting metadata regarding the predetermined point of time from the information regarding the predetermined point of time, and transmitting the metadata to the application program, wherein the information regarding the predetermined point of time is generated by receiving the metadata from the application program and matching the metadata with an identifier of the AV content.

According to an aspect of another exemplary embodiment, there is provided a computer readable recording medium having recorded thereon programs for executing the information storage method and the information reading method described above.

According to an aspect of another exemplary embodiment, there is provided an information reading apparatus including: a processor; and a browser driver which drives a browser, the browser comprising an API which receives information regarding a predetermined point of time, which is generated according to reproduction of AV content, wherein the information regarding the predetermined point of time is generated by receiving metadata regarding the predetermined point of time from the application program and matching the metadata with an identifier of the AV content, and wherein the API transmits the metadata, from among the read information regarding the predetermined point of time, to an application program related to the reproduction of the AV content.

### BRIEF DESCRIPTION OF THE DRAWINGS

The above and other aspects will become more apparent by describing in detail exemplary embodiments with reference to the attached drawings in which:

FIG. 1 is a block diagram of a device that includes an information storage apparatus and an information reading apparatus, according to an exemplary embodiment;

FIG. 2 is a block diagram of an application program and a browser, according to an exemplary embodiment;

FIG. 3 is a flowchart illustrating a method of generating and storing bookmark information, according to an exemplary embodiment;

FIG. 4 is a flowchart illustrating a method of generating and storing bookmark information, according to another exemplary embodiment;

FIG. 5 is a flowchart illustrating a method of reading bookmark information, according to an exemplary embodiment; and

FIG. 6 is a flowchart illustrating a method of reproducing AV content based on bookmark information, according to an exemplary embodiment.

### DETAILED DESCRIPTION OF EXEMPLARY EMBODIMENTS

Hereinafter, exemplary embodiments will be described in detail with reference to the accompanying drawings. Expressions such as “at least one of,” when preceding a list of elements, modify the entire list of elements and do not modify the individual elements of the list

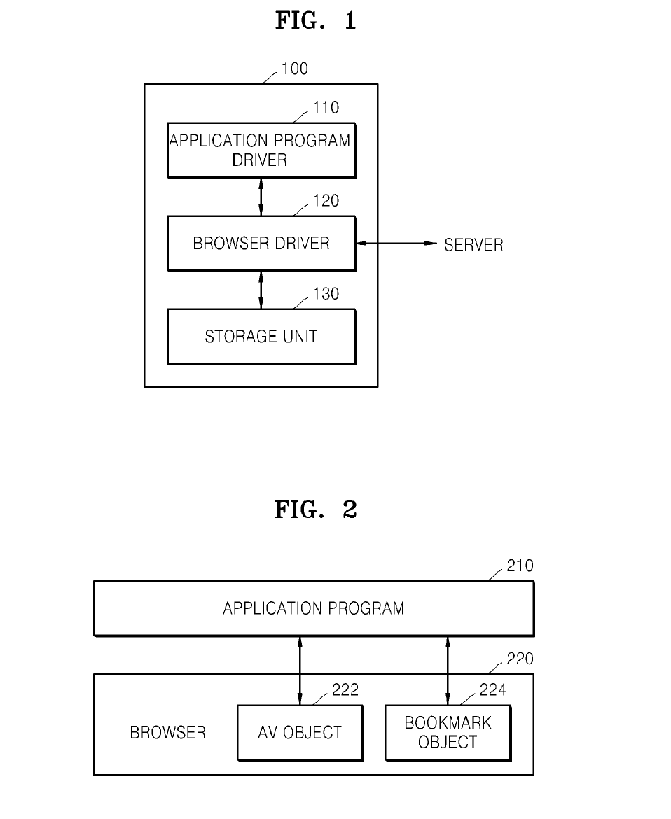

FIG. 1 is a block diagram of a device 100 that includes an information storage apparatus and an information reading apparatus, according to an exemplary embodiment. The device 100 may be a terminal device, e.g., a TV, a set-top box, a mobile device, etc., which receives and reproduces a digital broadcast signal.

Referring to FIG. 1, the device 100 may include an application program driver 110, a browser driver 120, and a storage unit 130.

The application program driver 110 drives an application program for providing a service. The application program may be installed in the device 100 during the manufacture of the device 100 or may be installed in the device 100 after the manufacture (e.g., by receiving data from the outside). As described above, in a digital broadcast service, data related to an application program may be transmitted and received via a broadcast signal. Similarly, the application program driven by the application program driver 110 may be received via a broadcast signal. If the device 100 includes a local area network (LAN) module, the application program may be received via an Internet protocol (IP) network.

The browser driver 120 drives a browser for providing an environment in which the application program driven by the application program driver 110 is executed. The browser driver 120 may include various types of application programming interfaces (APIs) to which the application program may have access, and may perform a particular operation when the application program calls one of the APIs. The browser driver 120 may also return the result of performing the operation to the application program.

According to an exemplary embodiment, the browser driven by the browser driver 120 may include an API that generates or reads information regarding a predetermined point of time during reproduction of AV content (hereinafter referred as ‘bookmark information’). The AV content may be digital content that is streamed via a broadcast signal or that is downloaded and stored in the storage unit 130 of the device 100. The digital content streamed via a broadcast signal may be digital broadcast content.

A case where bookmark information is generated will now be described. The application program driven by the application program driver 110 may request bookmark information regarding a predetermined point of time during reproduction of AV content. If the reproduction of the AV content is discontinued, the application program may note a point of time that the reproduction is discontinued so as to restart the reproduction of the AV content starting from the point of time. Thus, bookmark information may be stored, and the AV content may be reproduced again starting from the point of time by reading the stored bookmark information.

Since the application program may not directly control the elements of the device 100, e.g., the storage unit 130, the application program requests the bookmark information to be stored in the API included in the browser. In this case, metadata regarding the point of time may be transmitted to the API. For example, metadata that includes at least one of information regarding the point of time, the title of the AV content, and text input by a user to identify a bookmark may be transmitted to the API. The API generates bookmark information based on the metadata, and stores the bookmark information in the storage unit 130.

The generated bookmark information may also be stored in an external server or external storage device. If an entity that manages the generated bookmark information is an external server that is external to the device 100, the bookmark information may be stored in the external server.

The application program transmits the metadata to the API, and the API generates the bookmark information by directly matching the metadata with an identifier of the AV content. If the API generates the bookmark information by changing or modifying the metadata received from the application program and stores the bookmark information, then the API may read and change or modify the stored bookmark information again and transmits the result to the application program when the application program requests the bookmark information. Furthermore, the API may directly include the received metadata in the bookmark information without changing or modifying the received metadata. However, in order to identify the AV content related to the bookmark information, the bookmark information may be generated by matching the metadata with the identifier of the AV content. The identifier of the AV content may be an identifier for identifying streamed content or an identifier for identifying content downloaded and stored in the storage unit 130.

The bookmark information may be stored in a location in the storage unit 130, which is determined by the browser. Since the application program does not determine the location of the bookmark information and the bookmark information is stored in the location determined by the browser, the bookmark information may be stored without being interfered with by the application program. Alternatively, the API that is included in the browser and generates and stores the bookmark information may determine the location of the bookmark information.

If the metadata received from the application program is not changed or modified and is directly stored, then the amount of calculation performed by the browser to generate or read the bookmark information may be reduced. Furthermore, the storage location of the bookmark information may be determined by the browser, thereby lowering dependency of the API, which generates the bookmark information, upon the application program. Thus, various application programs driven by the browser may easily use the API that generates the bookmark information, thereby improving general use of the browser.

A case where stored bookmark information is read will now be described. The application program requests the API to provide bookmark information of AV content that is to be reproduced. In this case, the application program may transmit the identifier of the AV content to the API so that the API may provide the application program with bookmark information corresponding to the identifier of the AV content.

The API reads the bookmark information corresponding to the identifier of the AV content from the storage unit 130, and transmits the bookmark information to the application program. In this case, only metadata included in the read bookmark information may be extracted and transmitted to the application program.

That API that generates or reads bookmark information may generate and store information regarding a still image at a point of time when the bookmark information is generated. The information regarding the still image may be a file obtained by compressing the still image according to a predetermined still image compression method, e.g., in a Joint Photographic coding Experts Group (JPEG) format. The information regarding the still image may be included in bookmark information, and the still image may be used as a thumbnail image when the bookmark information is read.

When the information regarding the still image is generated and stored, the API may return location information of the still image stored, e.g., a Uniform Resource Locator (URL), to the browser or the application program, so that the information regarding the still image may be read together with the bookmark information or separately when the bookmark information is read.

FIG. 2 is a block diagram of an application program 210 and a browser 220, according to an exemplary embodiment. Referring to FIG. 2, the application program 210 that is related to reproduction of AV content, reproduces the AV content by using various APIs 222 and 224 included in the browser 220, and performs at least one of generating, storing, and reading bookmark information. The AV object 222 is an API that controls reproduction of the AV content, and the bookmark object 224 is an API that performs the at least one of the generating, storing, and reading of the bookmark information.

The application program 210 controls reproduction of the AV content by using the AV object 222. Specifically, the application program 210 transmits information regarding the AV content to the AV object 222 so that the AV object 222 may receive and reproduce the AV content. The information regarding the AV content may be information used by the AV object 222 to specify the AV content that is to be received. For example, the information regarding the AV content may include a URL of a content access descriptor (CAD) according to the Open Internet Protocol television Forum (OIPF).

The AV object 222 may perform various control operations, e.g., starting, pausing, and ending of reproduction of the AV content, to reproduce the AV content.

Also, the application program 210 may transmit a predetermined message to the bookmark object 224 so as to generate, store, or read the bookmark information.

The application program 210 may instruct that the bookmark information be generated by calling the bookmark object 224 by using a message ‘Boolean writeMetadata(string ContentID, string data)’ bookmark object 224. The “Boolean” added at the start of this message denotes the type of a value that is to be returned to the application program 210 by the bookmark object 224. ‘0’ or ‘1’ may be returned to the application program 210 so as to indicate whether the bookmark information is satisfactorily generated and stored, or read. The “ContentID” is an identifier of the AV content corresponding to the bookmark information, and the data type of the “ContentID” is a string. The “data” is metadata regarding a point of time when the bookmark information is generated, and the data type of the “data” is also a string. As described above, the bookmark object 224 may generate the bookmark information by directly matching metadata received from the application program 210 with the identifier of the AV content. If bookmark information is generated for a plurality of pieces of AV content or is generated several times for one piece of AV content, then the bookmark information may be stored to be sorted according to an identifier of the AV content.

The application program 210 may read the bookmark information by calling the bookmark object 224 by using a message ‘String readMetadata(String ContentID)’. The “String” added at the start of this message denotes the type of a value that is to be returned to the application program 210 by the bookmark object 224. Since the bookmark information is to be read, metadata regarding a point of time during reproduction of the AV content is returned and the data type of the metadata is a string. The ‘ContentID’ is an identifier that identifies the AV content of the bookmark information, and the data type of the ‘ContentID’ is also a string. If the application program 210 includes the identifier of the AV content, the bookmark information of which is stored, into the “readMetadata” and transmits the message to the bookmark object 224, then the bookmark object 224 reads the bookmark information corresponding to the “ContentID” included in the “readMetadata,” extracts the metadata from the bookmark information, and transmits the metadata to the application program 210.

As described above, the bookmark information may include information regarding a still image at a point of time when the bookmark information is generated. The application program 210 may generate the information regarding the still image by transmitting a predetermined message to the bookmark object 224.

The application program 210 may generate the information regarding the still image by calling the bookmark object 224 by using a message ‘String createCurrentImage(String ContentID)’.

The “String” added at the start of the message denotes the type of a value that the bookmark object 224 returns to the application program 210. The “String” is information regarding a location where the information regarding the still image is stored, and the data type thereof is a string. The “ContentID” is an identifier of the AV content corresponding to the bookmark information. If the application program 210 includes the identifier of the AV content into the “createCurrentImage” and transmits the message to the bookmark object 224, then the bookmark object 224 generates and stores the information regarding the still image of the AV content corresponding to the “ContentID,” and provides the application program 210 with the location information of the information regarding the still image.

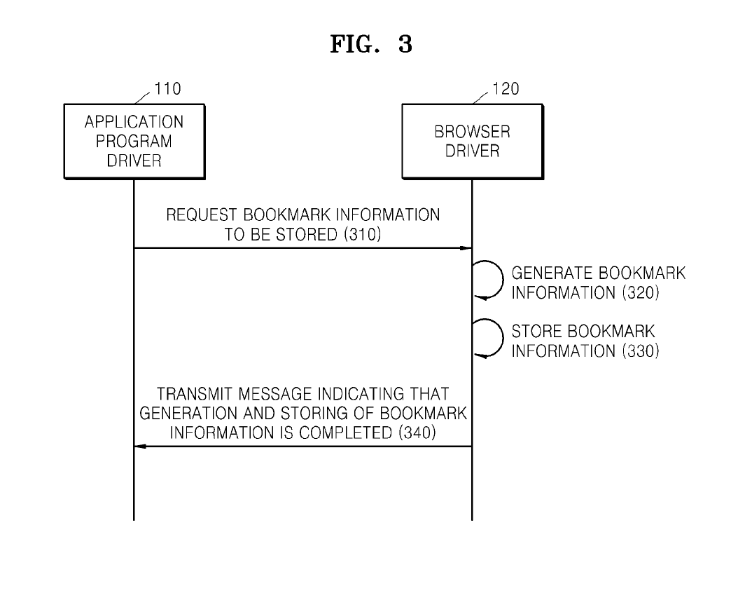

FIG. 3 is a flowchart illustrating a method of generating and storing bookmark information, according to an exemplary embodiment. Referring to FIG. 3, in operation 310, an application program driver 110 requests a browser driver 120 to store bookmark information. Specifically, an application program driven by the application program driver 110 may request information regarding a predetermined point of time during reproduction of AV content, i.e., bookmark information, to be stored. The application program may transmit a message “writeMetadata” as described above to an API (not shown) that generates bookmark information.

In operation 320, the browser driver 120 generates bookmark information according to the request given in operation 310. The message “writeMetadata” transmitted in operation 310 may contain metadata regarding the predetermined point of time. The API that generates bookmark information may generate the bookmark information by matching the metadata contained in this message with an identifier of the AV content. A method of generating bookmark information has been described above with reference to FIGS. 1 and 2.

In operation 330, the browser driver 120 stores the bookmark information generated in operation 320. The bookmark information may be stored in a location of the storage unit 130 of FIG. 1 determined by a browser (not shown). Also, the bookmark information may also be transmitted to an external server (not shown) or external storage device (not shown).

In operation 340, the browser driver 120 transmits a message indicating that generation and storing of the bookmark information is completed to the application program driver 110, in response to the request given in operation 310. The API of the browser driver 120 may set a return value, which indicates that the generation and storing of the bookmark information is completed, to ‘0’ or ‘1’ and may transmit the return value to the application program of the application program driver 110.

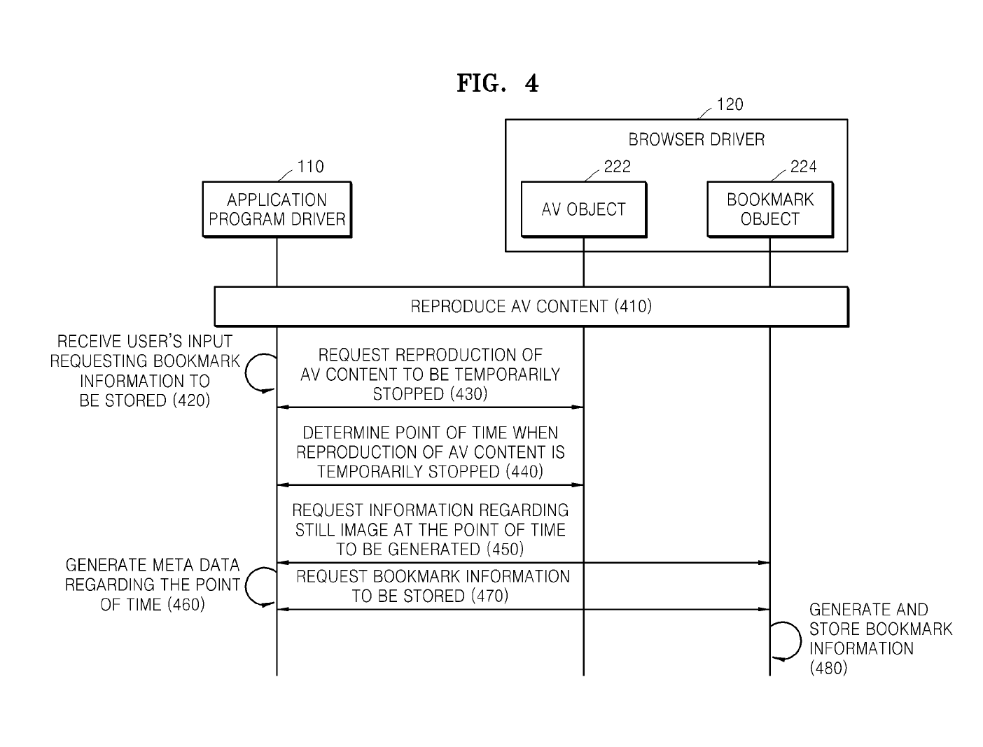

FIG. 4 is a flowchart illustrating a method of generating and storing bookmark information, according to another exemplary embodiment. Referring to FIG. 4, in operation 410, an application program driver 110 and a browser driver 120 reproduces AV content. An application program of the application program driver 110 may start the reproduction of the AV content by using an AV object 222, and may control the reproduction of the AV content.

In operation 420, the application program driver 110 may receive a user's input requesting bookmark information to be stored. The application program of the application program driver 110 may receive the user's input via an input module, remote controller, etc., of the device 100.

In operation 430, the application program driver 110 may request the browser driver 120 to stop (e.g., to temporarily stop) the reproduction of the AV content. In detail, the application program of the application program driver 110 may request the AV object 222 of the browser driver 120 to stop the reproduction of the AV content.

In operation 440, the application program driver 110 determines a point of time when the reproduction of the AV content is stopped. The application program may inquire of the AV object 222 about the point of time when the reproduction of the AV content is stopped, and may receive a return value regarding the point of time from the AV object 222, in response to the inquiry. The application program may receive information which will be included in metadata regarding the point of time from the AV object 222.

In operation 450, the application program driver 110 requests the browser driver 120 to generate information regarding a still image at the point of time determined in operation 440. The message “createCurrentImage” described above with reference to FIG. 2 may be transmitted to a bookmark object 224 of the browser driver 120. If the information regarding the still image is generated, the bookmark object 224 may provide the application program of the application program driver 110 with information regarding a URL of a location in which the information regarding the still image is stored.

In operation 460, the application program driver 110 generates the metadata regarding the point of time when the reproduction of the AV content is temporarily stopped.

In operation 470, the application program driver 110 requests the bookmark object 224 of the browser driver 120 to generate and store bookmark information. The ‘writeMetadata’ message described above with reference to FIG. 2 may be transmitted to the bookmark object 224. This message may contain the metadata regarding the point of time generated in operation 460.

In operation 480, the browser driver 120 generates and stores bookmark information based on the ‘writeMetadata’ message transmitted in operation 470. The bookmark information may be generated by matching the metadata contained in the message transmitted in operation 470 with an identifier of the AV content, and may then be stored. The bookmark information may be stored in a location of the storage unit 130 of FIG. 1, which is determined by a browser (not shown) or may be stored in an external server (not shown) or external storage device (not shown).

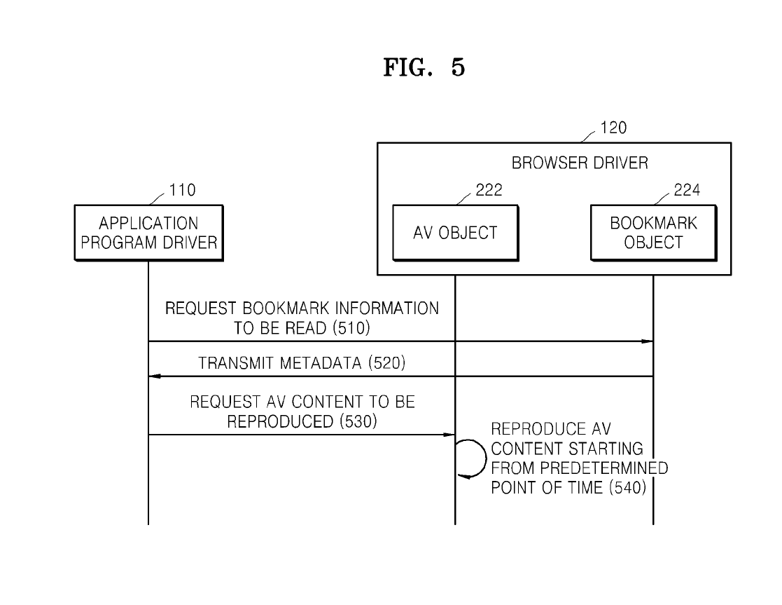

FIG. 5 is a flowchart illustrating a method of reading bookmark information, according to an exemplary embodiment. Referring to FIG. 5, in operation 510, an application program driver 110 requests a browser driver 120 to read bookmark information. If a user who is using an application of the application program driver 110 selects AV content, the bookmark information of which is stored, then the application program driver 110 requests a bookmark object 224 of the browser driver 120 to read the bookmark information of the selected AV content. In this case, the application program driver 110 may transmit the ‘readMetadata’ message described above with reference to FIG. 2 to the bookmark object 224.

In operation 520, the browser driver 120 reads the bookmark information requested in operation 510, extracts metadata from the bookmark information, and transmits the metadata to the application program driver 110. The bookmark object 224 reads the bookmark information corresponding to an identifier of the AV content, which is included in the ‘readMetadata’ message received in operation 510. The bookmark object 224 extracts the metadata from the read bookmark information and transmits the metadata to an application program of the application program driver 110. In this case, the bookmark information may be read from the storage unit 130 or an external server (not shown) or external storage device (not shown).

In operation 530, the application program driver 110 requests the browser driver 120 to reproduce the AV content, based on the metadata received in operation 520. A point of time when the reproduction of the AV content is to be started is determined based on the metadata received in operation 520. If this point of time is determined, the AV content is requested to be reproduced starting from the determined point of time. The application program driver 110 requests an AV object 222 of the browser driver 120 to reproduce the AV content.

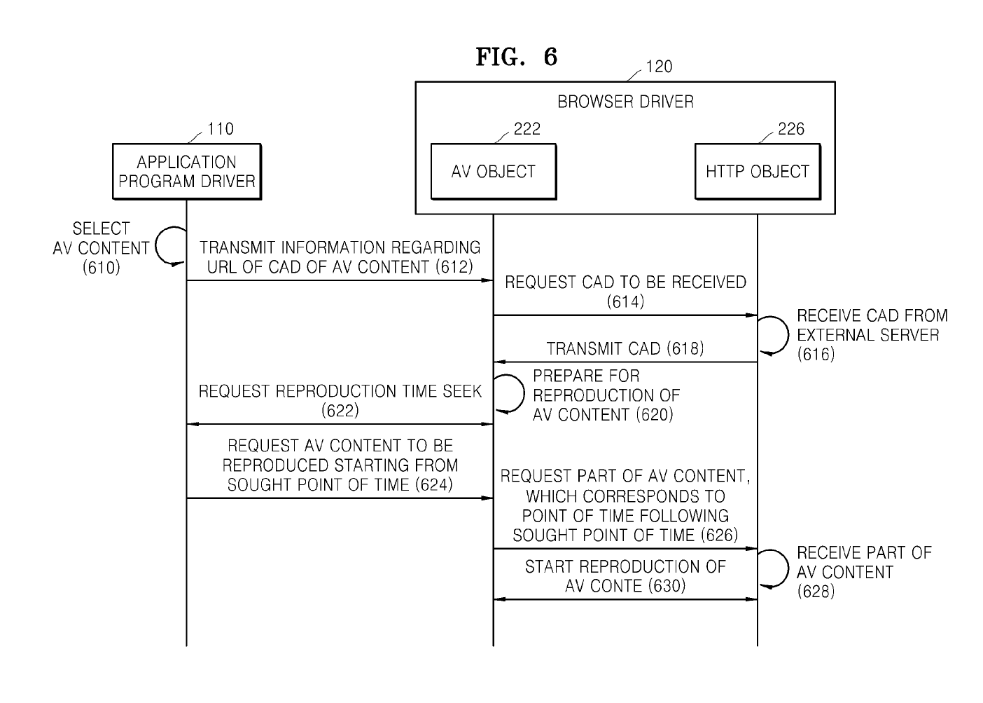

In operation 540, the browser driver 120 reproduces the AV content starting from the point of time determined in operation 530. Operations 530 and 540 will be described in detail below with reference to FIG. 6.

In the method of FIG. 5, bookmark information is read using the bookmark object 224 of the browser driver 120. However, as described above, when the bookmark information is stored in an external server (not shown), the bookmark information may be read directly from the external server without using the bookmark object 224. For example, the application program of the application program driver 110 may request the external server to provide the bookmark information and receive the bookmark information from the external server, via a network protocol object included in a browser (not shown). The network protocol object may be a hypertext transfer protocol (HTTP) object that supports connection between the device 100 of FIG. 1 and an external entity in a network. The application program transmits a message requesting the bookmark information and containing the URL of the bookmark information stored in the external server to the HTTP object, according to the Asynchronous JavaScript & eXtensible markup language (AJAX). The HTTP object may transmit the message requesting the bookmark information to the external server according to an HTTP and the URL, and may receive the bookmark information in reply to this message. The received bookmark information is transmitted to the application program. The HTTP object may request the external server to provide metadata regarding a predetermined point of time during the reproduction of the AV content other than the bookmark information, and may receive the metadata.

FIG. 6 is a flowchart illustrating a method of reproducing AV content based on bookmark information, according to an exemplary embodiment. In FIG. 6, operations 530 and 540 of FIG. 5 are illustrated in detail.

Referring to FIG. 6, in operation 610, an application program driver 110 selects AV content that is bookmarked. In this case, AV content, the bookmark information of which is stored, may be selected and the bookmark information of the selected AV content may be read.

In operation 612, the application program driver 110 transmits information regarding the URL of a CAD of the AV content to an AV object 222 of the browser driver 120. Since the AV object 222 should receive the AV content selected in operation 610 to reproduce the AV content, the information regarding the URL of the CAD according to the OIPF used to receive the AV content is transmitted to the AV object 222.

In operation 614, the AV object 222 requests an HTTP object 226 to receive the CAD. The AV object 222 may transmit a message requesting the CAD and containing the URL of the CAD to the HTTP object 226.

In operation 616, the HTTP object 226 receives the CAD from an external server (not shown) in response to the request of the AV object 222. The HTTP object 226 requests the external server to provide the CAD, based on the URL contained in the message received in operation 614, and receives the CAD from the external server in reply to the request. In operation 618, the received CAD is transmitted to the AV object 222.

In operation 620, the AV object 222 receiving the CAD prepares for reproduction of the AV content, based on the CAD. For example, the URL of the AV content is detected.

In operation 622, when the preparation for reproduction of the AV content is completed, an application program of the application program driver 110 requests a reproduction time seek so as to set a point of time determined based on the bookmark information as a point of time when the reproduction of the AV content will start. In operation 624, when reproduction time is sought, the AV content is requested to be reproduced starting from the sought point of time.

In operation 626, the AV object 222 requests the HTTP object 26 to provide a part of the AV content, which corresponds to a point of time following the sought point of time. Only the part of the AV content, which corresponds to the point of time following the sought point of time, may be requested based on the URL of the AV content detected in operation 620.

In operation 628, the HTTP object 226 receives the part of the AV content, which corresponds to the point of time following the sought point of time. In operation 630, the HTTP object 226 transmits the part of the AV content to the AV object 222 so as to begin the reproduction of the AV content.

While exemplary embodiments have been particularly shown and described above, it will be understood by those of ordinary skill in the art that various changes in form and details may be made therein without departing from the spirit and scope of the present inventive concept as defined by the appended claims. Furthermore, an exemplary embodiment may be embodied as computer readable code in a computer readable recording medium.

For example, each of an information storage apparatus and an information reading apparatus according to an exemplary embodiment may include a bus coupled to elements thereof as illustrated in FIG. 1, and at least one processor connected to the bus. Each of the information storage apparatus and the information reading apparatus may further include memory that is connected to the bus so as to store commands or a received or generated message and that is coupled to the at least one processor so as to execute the commands.

The computer readable recording medium may be any non-transitory recording apparatus capable of storing data that is read by a computer system, e.g., read-only memory (ROM), random access memory (RAM), a compact disc (CD)-ROM, a magnetic tape, a floppy disk, an optical data storage device, and so on. The computer readable medium can be distributed among computer systems that are interconnected through a network, and the present invention may be stored and implemented as computer readable code in the distributed system.

According to the above exemplary embodiments, a browser may directly store metadata related to bookmark information received from an application program without having to change or modify the metadata. Accordingly, it is possible to enable various application programs to either generate and store or read bookmark information by using an API provided by the browser, thereby improving general use of the browser.

What is claimed is:

1. An information storage apparatus comprising:
a browser driver which drives a browser, the browser comprising an application programming interface (API) which generates information regarding a point of time according to reproduction of audio/video (AV) content; and
a storage unit which stores the information regarding the point of time,
wherein the API generates the information regarding the point of time by receiving metadata regarding the point of time from an application program related to the reproduction of the AV content, and matching the metadata with an identifier of the AV content.

2. The information storage apparatus of claim 1, wherein the information regarding the point of time comprises information regarding a still image of the AV content at the point of time.

3. The information storage apparatus of claim 1, wherein the AV content comprises digital content.

4. The information storage apparatus of claim 1, wherein the storage unit stores the information regarding the point of time in a location determined by the browser.

5. The information storage apparatus of claim 2, wherein the browser driver provides the application program with information regarding a location, of the storage unit, in which the information regarding the still image is stored.

6. An information reading apparatus comprising:
a storage unit which stores information regarding a point of time, which is generated according to reproduction of audio/video (AV) content; and
a browser driver which drives a browser, the browser comprising an application programming interface (API) which reads the information regarding the point of time,
wherein the information regarding the point of time is generated by receiving metadata regarding the point of time from the application program and matching the metadata with an identifier of the AV content, and
wherein the API transmits the metadata, from among the read information regarding the point of time, to an application program related to the reproduction of the AV content.

7. The information reading apparatus of claim 6, wherein the information regarding the point of time comprises information regarding a still image of the AV content at the point of time.

8. The information reading apparatus of claim 6, wherein the AV content comprises digital content.

9. An information storage method comprising:
receiving metadata regarding a point of time determined according to reproduction of audio/video (AV) content from an application program related to the reproduction of the AV content;
generating information regarding the point of time by matching the received metadata with an identifier of the AV content; and
storing the generated information regarding the point of time in a storage device.

10. The information storage method of claim 9, wherein the generating the information regarding the point of time comprises generating information regarding a still image of the AV content at the point of time.

11. The information storage method of claim 9, wherein the AV content comprises digital content.

12. The information storage method of claim 9, wherein the storing the information regarding the point of time comprises storing the information regarding the point of time in a location determined by a browser comprising an application programming interface (API) which generates the information regarding the point of time.

13. The information storage method of claim 10, further comprising providing the application program with information regarding a location, of the storage device, in which information regarding the still image stored.

14. An information reading method comprising:
receiving a request to read information regarding a point of time, which is generated according to reproduction of audio/video (AV) content, from an application program related to the reproduction of the AV content;
reading the information regarding the point of time from a storage device, in response to the received request; and
extracting metadata regarding the point of time from the information regarding the point of time, and transmitting the extracted metadata to the application program,
wherein the information regarding the point of time is generated by receiving the metadata from the application program and matching the metadata with an identifier of the AV content.

15. The information reading method of claim 14, wherein the reading the information regarding the point of time comprises reading information regarding a still image of the AV content at the point of time.

16. The information reading method of claim 14, wherein the AV content comprises digital content.

17. A computer readable recording medium having recorded thereon a computer program for executing the method of claim 9.

18. A computer readable recording medium having recorded thereon a computer program for executing the method of claim 14.

19. The information storage method of claim 9, wherein the storing the generated information comprises storing the generated information in an external storage device.

20. The information reading method of claim 14, wherein the reading the information comprises receiving the information from an external storage device.

21. An information reading apparatus comprising:
a processor; and
a browser driver which drives a browser, the browser comprising an application programming interface (API) which receives information regarding a point of time, which is generated according to reproduction of audio/video (AV) content,
wherein the information regarding the point of time is generated by receiving metadata regarding the point of time from the application program and matching the metadata with an identifier of the AV content, and
wherein the API transmits the metadata, from among the read information regarding the point of time, to an application program related to the reproduction of the AV content.

22. The information reading apparatus according to claim 21, wherein the browser driver further comprises a network protocol object which receives the information regarding the point of time from an external storage device.
